(19) United States
(12) Patent Application Publication
(10) Pub. No.: US 2011/0265611 A1
(43) Pub. Date: Nov. 3, 2011

(54) APPARATUS FOR ACTUATING FASTENERS ARRANGED IN RESTRICTED PERIPHERAL CONFIGURATION

(76) Inventor: Venkatesh RAMAN, Bangalore (IN)

(21) Appl. No.: 12/771,117

(22) Filed: Apr. 30, 2010

(51) Int. Cl. B25B 27/00

(52) U.S. Cl. 81/57.22; 81/57.36

(57) ABSTRACT

An apparatus for actuating fasteners includes at least first and second base supports, a plurality of engagement tools, and a compound peripheral actuator. The base supports are configured so that when they are brought into operable alignment, they form a periphery with an open interior, for extending around a first part connected to a second part. The engagement tools are rotatably coupled to the base supports, and each includes a rotator member and a fastener coupler. The compound peripheral actuator is dimensioned to extend around and engage the rotator members of the engagement tools around the periphery. In operation, the base supports are deployed around the first part, and moved for engagement of the fastener couplers with fasteners connecting the first part to the second part. The compound peripheral actuator is deployed to engage and rotate the rotator members, for simultaneous rotation of the fasteners connected to the fastener couplers.

### FIELD OF THE INVENTION

Embodiments of the invention relate to machine tools and other tools. Other embodiments relate to tools for actuating bolts and other fasteners.

### BACKGROUND OF THE INVENTION

In a mechanical system or device, certain parts of the device may be connected to one another using bolts or other fasteners that are arranged in a circular or other peripheral configuration. A “peripheral configuration” refers to an arrangement where there are plural fasteners located around a periphery or boundary, but without any fasteners located within the interior area defined by the periphery. For example, the fasteners may be regularly spaced as if around the circumference of a circle.

In one specific type of peripheral configuration, the interior area between the fasteners is restricted, meaning occupied by a portion of the mechanical system or device that does not allow practical access by a tool that must be positioned coaxial with the interior area. A typical example of such a configuration is shown in FIGS. 1A and 1B. As illustrated, a first part 100 and a second part 102 are abutted for connection to one another. Each part 100, 102 includes an end flange 104a, 104b, respectively, that extends around the periphery of an end (in this example) of a shaft-like body 106a, 106b of the part. The two parts 100, 102 are connected to one another using bolts or other fasteners 108, which are tightened into place through threaded bolt holes or other aligning apertures 110 formed in the flanges 104a, 104b for this purpose. As should be appreciated, the interior area 112 between the fasteners 108 is restricted, since it is occupied by the part bodies 106a, 106b, which would prevent accessing the fasteners by a tool that would have to be positioned coaxial with an axis 114 of the parts or otherwise within the interior area 112.

### BRIEF DESCRIPTION OF THE INVENTION

Embodiments of the present invention relate to an apparatus for actuating fasteners. The apparatus comprises at least first and second base supports, a plurality of engagement tools, and a compound peripheral actuator. The base supports are dimensioned or otherwise configured so that when they are brought into operable alignment, they form a periphery with an open interior, for extending around a first part to be connected to (or disconnected from) a second part. The plurality of engagement tools are rotatably coupled to the first and second base supports; that is, some of the engagement tools are connected to the first base support and some of the engagement tools are connected to the second base support. Each engagement tool comprises a rotator member and a fastener coupler connected to the rotator member. (“Rotator member” refers to a part adapted or configured to be engaged so as to rotate the engagement tool. “Fastener coupler” refers to a part adapted to engage or couple to a bolt or other fastener.) The compound peripheral actuator is dimensioned to extend around and engage the rotator members of the engagement tools around the periphery.

In an embodiment, in operation of the apparatus, the base supports are disconnected from one another, or at least partially separated (e.g., the base supports may be hinged together at one end), and deployed about a first part, such as a part comprising a shaft body. That is, the base supports are at least partially separable from one another for the base supports to be moved radially towards and deployed about the first part. The first part may abut a second part to which the first part is to be connected to or disconnected from. The base supports are then brought into operable alignment with one another to extend around the first part. The apparatus is then moved for engagement of the fastener couplers with fasteners connecting the first and second parts; alternatively, if the first part is not yet connected to the second part, fasteners may first be loaded in the fastener couplers for connecting the two parts together. The compound peripheral actuator is deployed to engage the rotator members. Movement of the compound peripheral actuator causes rotation of the plurality of engagement tools for simultaneous rotation of the fasteners connected to the fastener couplers.

As should be appreciated, embodiments of the apparatus facilitate actuating fasteners arranged in a restricted peripheral configuration, where an interior area between the fasteners is occupied a part body that prevents use of a tool that would have to be deployed coaxial with the part body to engage the fasteners. Instead, the apparatus includes plural engagement tools that can be “wrapped around” the part body (with no portion of the apparatus lying between the periphery of the engagement tools) and rotated together for simultaneous actuation of the fasteners coupled to the engagement tools.

### BRIEF DESCRIPTION OF THE DRAWINGS

The present invention will be better understood from reading the following description of non-limiting embodiments, with reference to the attached drawings, wherein below:

FIG. 1A is a perspective view of two parts connected to one another;

FIG. 1B is a side elevation view, partially in section, of two parts connected to one another;

FIGS. 2 and 3 are top plan and perspective views, respectively, of an apparatus for actuating fasteners arranged in a restricted peripheral configuration, according to embodiments of the present invention;

FIGS. 4A and 4B are top plan views of embodiments of the apparatus in a second mode and a third mode of operation, respectively, and FIG. 4C is a perspective view of part of FIG. 4B looking towards line 4C-4C in FIG. 4B;

FIGS. 5A and 5B are perspective views of embodiments of the apparatus in the second and third modes of operation, respectively;

FIG. 6 is a sectional view of the apparatus, as deployed in operation around a part, taken along line 6-6 of FIG. 5B;

FIG. 7 is a perspective view of an additional embodiment of the apparatus for actuating fasteners, in relation to two parts connected together by fasteners;

FIG. 8 is a top plan view of an additional embodiment of the apparatus for actuating fasteners;

FIG. 9 is a top plan view of an embodiment of the apparatus for actuating fasteners, where the apparatus includes a flexible compound peripheral actuator;

FIGS. 10A and 10B are schematic top plan views of embodiments of the apparatus, illustrating certain dimensions of the apparatus;

FIG. 11 is a schematic top plan view of an embodiment of the apparatus;

FIG. 12 is an exploded side elevation view of an embodiment of an engagement tool portion of the apparatus;

FIGS. 13A and 13B are side elevation exploded and assembled views, respectively, of another embodiment of an engagement tool portion of the apparatus;

FIG. 14 is a cross section view of an alternative embodiment of an engagement tool; and

FIGS. 15A and 15B are a top plan view and end view, respectively, of part of an additional embodiment of an apparatus for actuating fasteners arranged in a restricted peripheral configuration.

### DETAILED DESCRIPTION OF THE INVENTION

As described in more detail below, embodiments of the present invention relate to an apparatus for actuating fasteners that are arranged in a peripheral configuration, e.g., a restricted peripheral configuration. The apparatus comprises at least first and second base supports, a plurality of engagement tools, and a compound peripheral actuator. The base supports are dimensioned or otherwise configured so that when they are brought into operable alignment, they form a periphery with an open interior, for extending around a first part to be connected to (or disconnected from) a second part. The plurality of engagement tools are rotatably coupled to the first and second base supports; that is, some of the engagement tools are connected to the first base support and some of the engagement tools are connected to the second base support. Each engagement tool comprises a rotator member and a socket or other fastener coupler connected to the rotator member. (As noted above, “rotator member” refers to a part adapted or configured to be engaged to rotate the engagement tool, and “fastener coupler” refers to a part adapted to engage or couple to a bolt or other fastener.) The compound peripheral actuator is dimensioned to extend around and engage the rotator members of the engagement tools around the periphery.

In an embodiment, in operation of the apparatus, the base supports are disconnected from one another, or at least partially separated (e.g., the base supports may be hinged together at one end), and deployed about a first part, such as a part comprising a shaft body. The first part may abut a second part to which the first part is to be connected to or disconnected from. The base supports are then brought into operable alignment with one another to extend around the first part. In this position, the engagement tools are arranged as around a periphery that corresponds to the peripheral configuration/spacing of the fasteners to be engaged by the apparatus, for alignment of the engagement tools with the fasteners. The apparatus is then moved axially (i.e., towards the fasteners) for engagement of the fastener couplers with the fasteners, which connect the first and second parts; alternatively, if the first part is not yet connected to the second part, fasteners may first be loaded in the fastener couplers for connecting the two parts together. The compound peripheral actuator is deployed to engage the rotator members. Movement of the compound peripheral actuator causes rotation of the plurality of engagement tools for simultaneous rotation of the fasteners connected to the fastener couplers.

In another embodiment, each engagement tool comprises a shaft attached to one of the first or second base supports. (That is, for those engagement tools connected to the first base support, the shaft of each of those engagement tools is attached to the first base support, and for those engagement tools connected to the second base support, the shaft of each of those engagement tools is attached to the second base support.) The rotator member comprises a pinion gear having a longitudinal through-bore, with the rotator member being disposed about the shaft and the shaft extending through the through-bore. The fastener coupler is attached to the pinion gear. (The term “pinion” gear is used as a part naming convention, to differentiate the pinion gear from other gears in the apparatus, and is not meant to confer or describe a particular characteristic of the pinion gear except that each pinion gear may have a smaller diameter than an effective diameter of the compound peripheral actuator, so that the compound peripheral actuator may engage the plural pinion gears of the engagement tools.)

In an embodiment, the pinion gear comprises first and second pinion gear sections, which are attached to and coaxial with one another. The first pinion gear section defines a first section of the through-bore having a first diameter, and the second pinion gear section defines a second section of the through-bore having a second, larger diameter. An interior end of the first pinion gear section, defined between the first diameter and the second diameter, forms a landing. The engagement tool further comprises a spring positioned within the second section of the through-bore in the second pinion gear section of the pinion gear, and disposed over the shaft. The spring abuts the landing and/or the first or second base support (as applicable). The spring provides the engagement tool with a degree of freedom of movement to accommodate variances in fastener spacing and torque limiting capability.

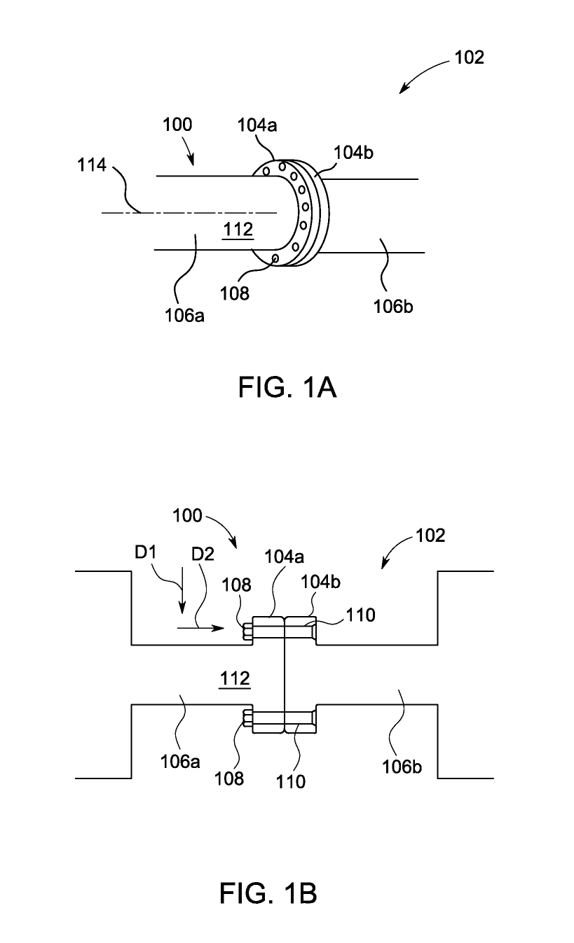

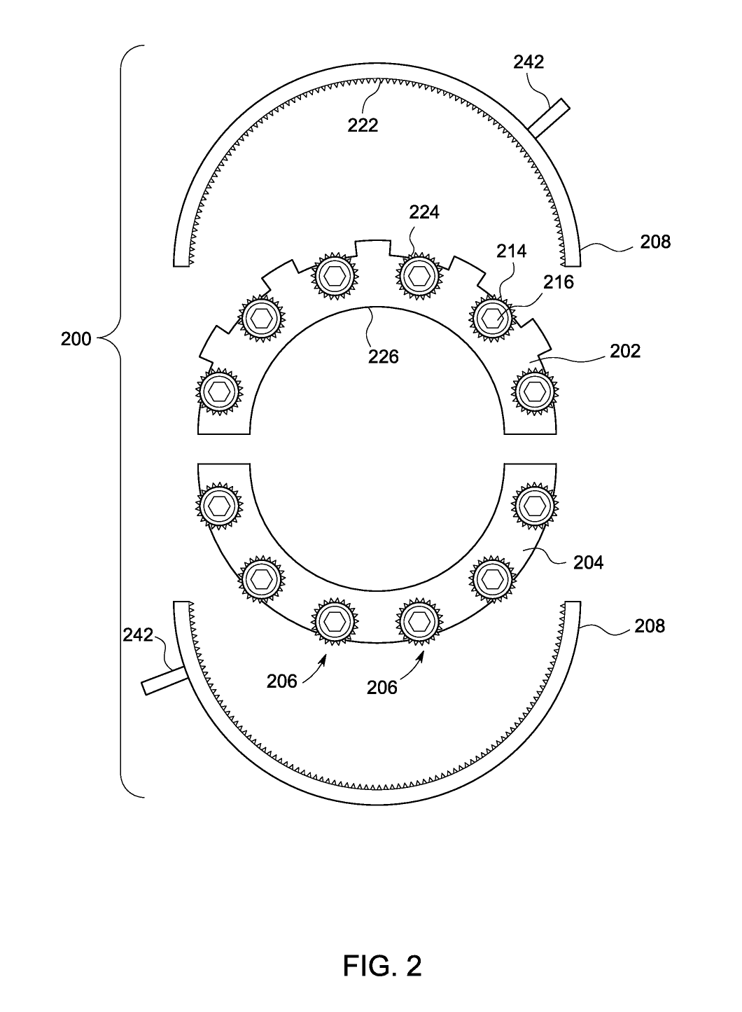

In an embodiment, for use of the apparatus in actuating fasteners that are arranged in a circular restricted peripheral configuration (for example, as in FIGS. 1A and 1B), each of the base supports is an arcuate semi-circle. Here, when the base supports are brought together into operable alignment, they form a circular periphery, with the plurality of engagement tools being positioned around the circular periphery.

In the case where the engagement tools are arranged as around a circular periphery, and where the rotator members of the engagement tools are pinion gears, the compound peripheral actuator may be a compound ring gear that is dimensioned to engage the pinion gears when the first and second base supports are brought into operable alignment to form the circular periphery.

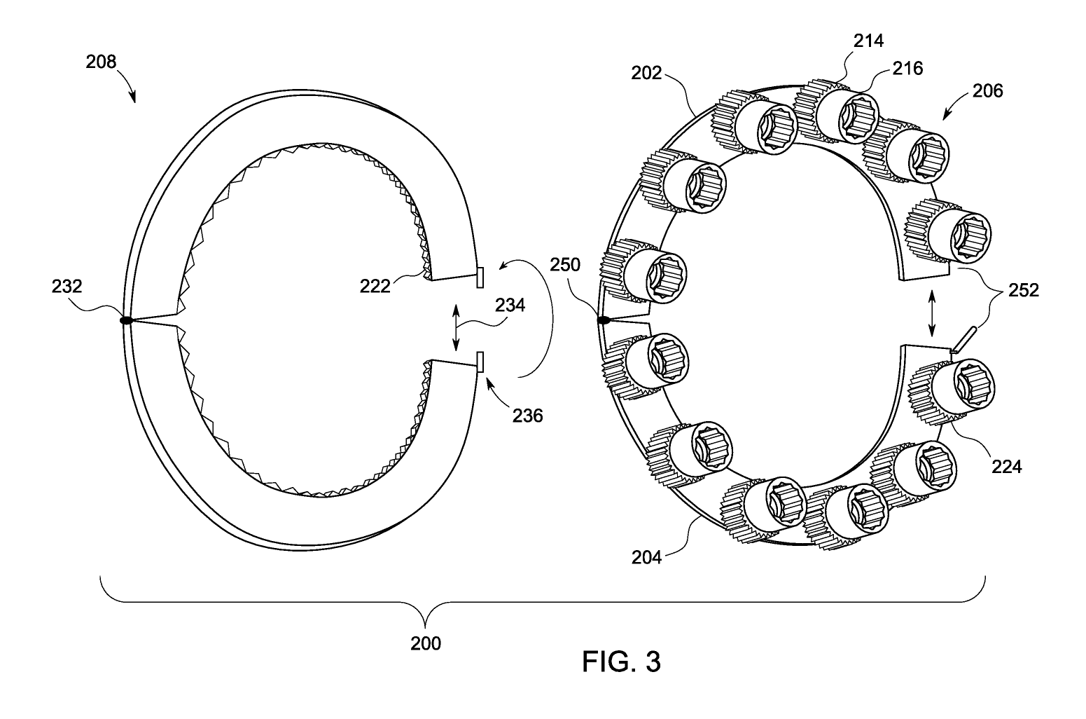

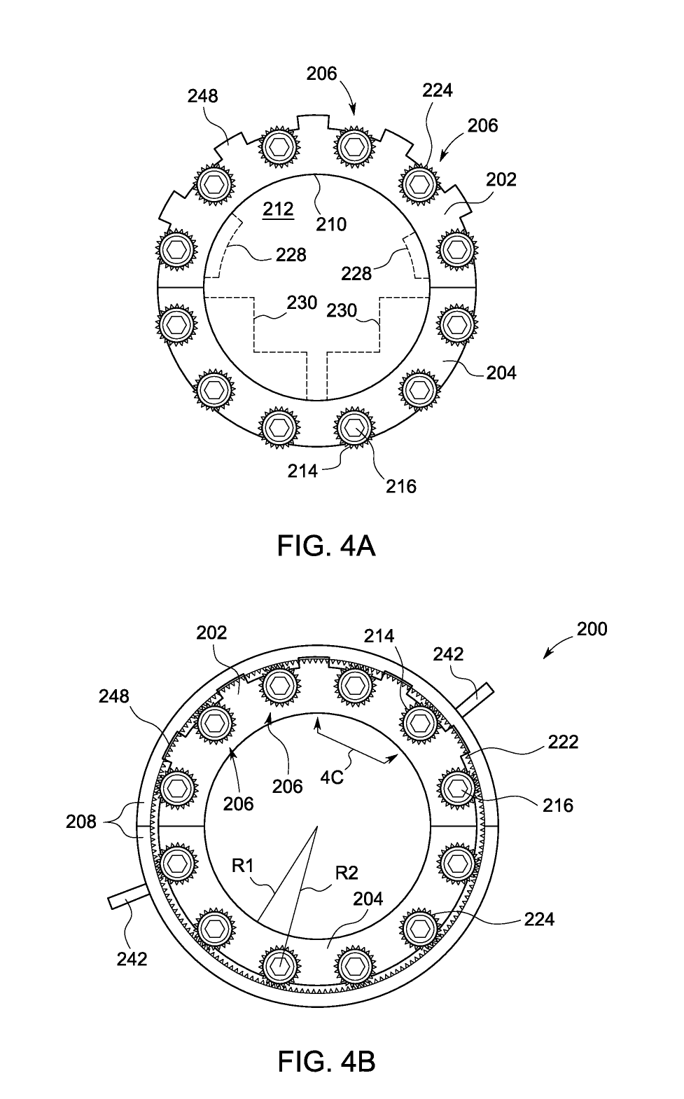

FIGS. 2, 3, 4A, 4B, and 4C illustrate embodiments of an apparatus 200 for actuating fasteners 108 arranged in a peripheral configuration, e.g., a restricted peripheral configuration. The apparatus 200 includes a first base support 202, a second base support 204, a plurality of engagement tools 206, and a compound peripheral actuator 208. The base supports 202, 204 are dimensioned or otherwise configured so that when they are brought into operable alignment (see FIG. 4A), they form an inner periphery 210 with an open interior 212, for extending around a first part 100 to be connected to (or disconnected from) a second part 102. The plurality of engagement tools 206 are rotatably coupled to the first and second base supports 202, 204; that is, some of the engagement tools (e.g., a first plurality of the engagement tools) are connected to the first base support and some of the engagement tools (e.g., a second, distinct plurality of the engagement tools) are connected to the second base support. Each engagement tool 206 comprises a rotator member 214 and a socket or other fastener coupler 216 connected to the rotator member 214. (As noted above, “rotator member” refers to a part adapted or configured to be engaged to rotate the engagement tool 206, and “fastener coupler” refers to a part adapted to engage or couple to a bolt or other fastener 108.) The compound peripheral actuator 208 is dimensioned to extend around and engage the rotator members 214 of the engagement tools 206 around the periphery (see FIGS. 4B and 4C).

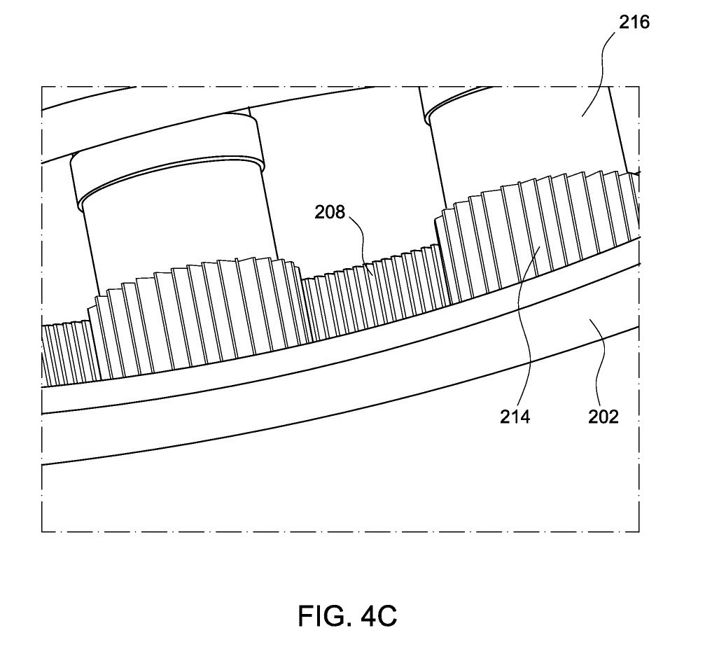

In an embodiment, in operation of the apparatus 200, the base supports 202, 204 are disconnected from one another (see FIG. 2), or at least partially separated (e.g., the base supports may be hinged together at one end, as in FIG. 3), and deployed about a first part 100, such as a part comprising a shaft body 106a. The first part 100 may abut a second part 102 to which the first part 100 is to be connected to or disconnected from. The base supports 202, 204 are then brought into operable alignment with one another (see FIG. 4A) to extend around the first part 100 (see FIG. 5A). In this position, the engagement tools 206 are positioned as around a periphery that corresponds to the peripheral configuration/spacing of the fasteners 108, for alignment of the engagement tools 206 with the fasteners 108. (Thus, the term “operable alignment” of the base supports means bringing the base supports together so that the engagement tools 206 of the base supports are arranged to align with fasteners 108 of a part with which the apparatus is used.) The apparatus 200 is then moved axially for detachable engagement of the fastener couplers with fasteners 108 connecting the first and second parts 100, 102; alternatively, if the first part is not yet connected to the second part, fasteners may first be loaded in the fastener couplers for connecting the two parts together. The compound peripheral actuator 208 is deployed (see FIG. 4B and FIG. 5B) to engage the rotator members 214. Movement of the compound peripheral actuator 208 causes rotation of the plurality of engagement tools 206 for simultaneous rotation of the fasteners 108 connected to the fastener couplers 216.

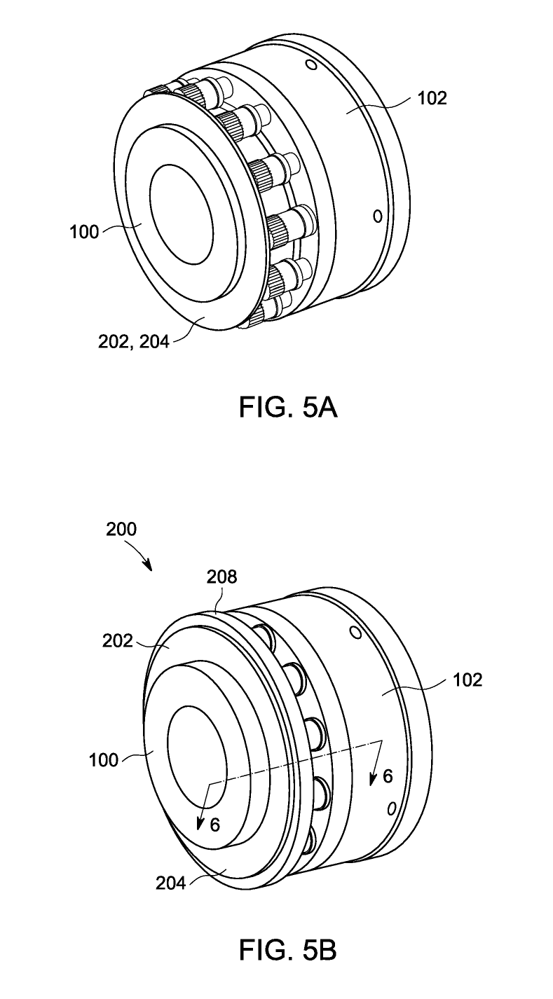

FIG. 6 is a sectional view of an embodiment of the apparatus 200 as taken along line 6-6 of FIG. 5B. Here, the apparatus 200 is deployed for use in actuating fasteners 108 arranged in a restricted peripheral configuration. (Specifically, the fasteners are arranged in a regular circular restricted peripheral configuration.) FIG. 6 shows one of the fasteners 108, which in this example connects a first part 100 to a second part 102 through a flange 104a on the first part. The base support (which could be either 202 or 204 in this view) abuts and extends around the first part 100. In this example, the shown engagement tool 206 comprises a shaft 218 attached to the base support 202 or 204. The rotator member 214 is a pinion gear having a longitudinal through-bore 220, with the rotator member being disposed about the shaft and the shaft extending through the through-bore. The fastener coupler 216, which in this case is a socket, is attached to the pinion gear, on the side of the pinion gear away from the shaft 218, for detachable coupling with the head of the fastener 108. In this case, the compound peripheral actuator 208 is a compound ring gear, which wraps around and engages the outer side of the pinion gear rotator member 214. The pitch of the teeth 222 of the compound ring gear are complementary to the teeth 224 of the pinion gear rotator members 214, so that rotation of the compound ring gear causes corresponding rotation of the pinion gear rotator members.

The base supports 202, 204 may be relatively thin, flat, rigid sections of material (e.g., metal, polymer, composite). The base support 202 or 204 in FIG. 6, for example, has a rectangular cross-section, with a cross-width that is significantly greater than the height of the base support. As perhaps shown best in FIGS. 2 and 4A, each base support 202, 204 may have at least an interior edge 226 (see FIG. 2) that corresponds in shape to the outer cross-periphery of the part 100 with which the apparatus 200 is intended for use, with the base supports each defining a radius “R1” that corresponds to the radius of the portion (e.g., the shaft-like body 106a) of the part 100 around which the bases supports are wrapped/positioned. The engagement tools 206 in turn are positioned radially outwards from the interior edge 226 at a second radius “R2,” which corresponds to the center point/axis positioning of the fasteners 108 with respect to the center axis of the part 100, for automatic alignment of the engagement tools 206 with fasteners 108 when the base supports are positioned against the part 100. Alternatively, the base supports could be dimensioned to have a radius R1 greater than a radius of the portion (e.g., the shaft-like body 106a) of the part 100 around which the base supports are wrapped/positioned, with the base supports thereby not abutting the part. Or removable spacer units 228 (see FIG. 4A) could be attached to the interior edge 226 of the base supports for adjusting the effective radius of the base supports for abutting different sized parts 100, 102.

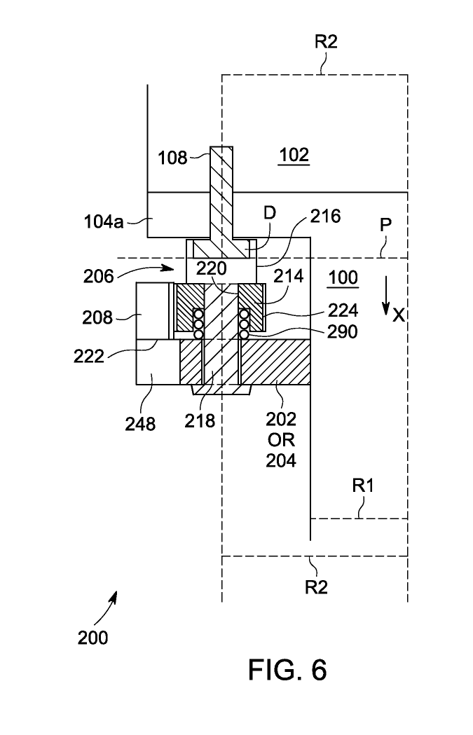

As should be appreciated, radius dimensions R1, R2 are applicable to cases where the shaft-like body 106a of the part 100, around which the base supports are positioned, are circular in cross-section. In such a case, each base support 202, 204 may be arcuate/semi-circular in shape, as illustrated in FIGS. 2-5B. However, the apparatus is not limited for use with parts having a circular cross-section. Instead, in certain embodiments of the apparatus, the base supports are non-circular in shape, for use with parts that are correspondingly non-circular. An example is shown in FIG. 7. Here, parts 100, 102 have square (or, more generally, rectangular) shaft bodies, which are connected to one another by fasteners 108 through square flanges 104a, 104b, respectively. Since the parts 100, 102 are square or rectangular in cross-section, the fasteners 108 are arranged in a corresponding rectangular peripheral configuration. Additionally, the base supports 202, 204 are correspondingly configured so that when the base supports are brought into operable alignment around the square or rectangular part 100 (e.g., wrapped around and/or abutting the part, with the two base supports contacting/abutting one another at their end edges), they form a square or rectangular periphery with an open interior that corresponds to the shape of the part 100. In this position of the base supports, the engagement tools 206 are arrayed around the square or rectangular periphery of the base supports in alignment with the fasteners 108 (and/or with apertures in which fasteners are intended to be inserted).

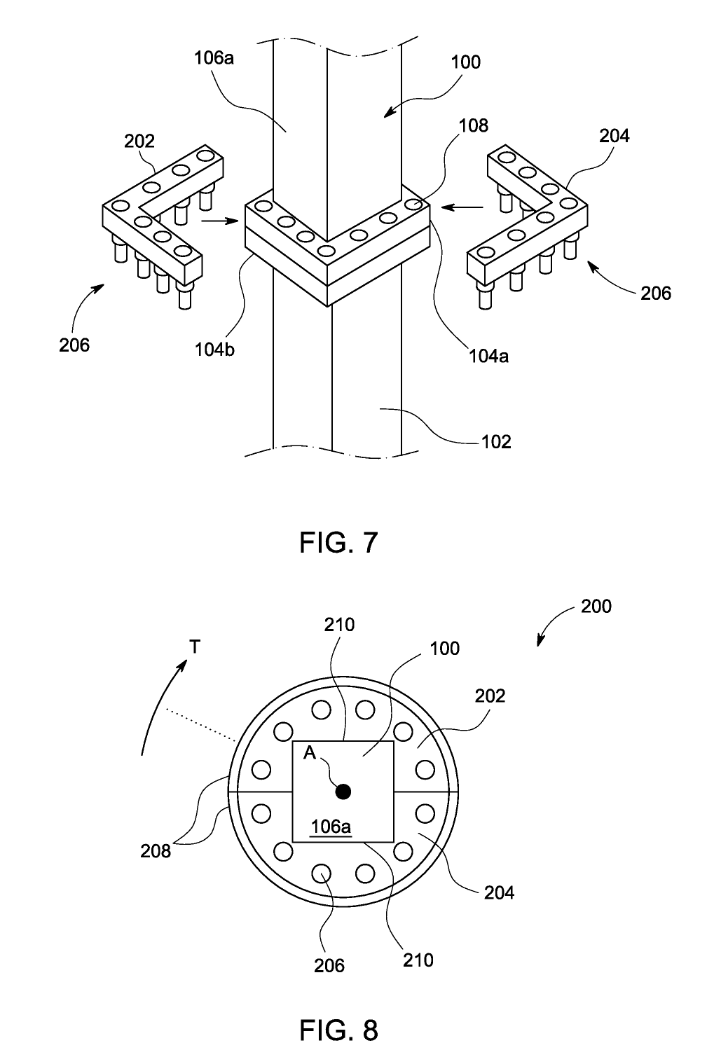

In an embodiment, the inner periphery 210 of the base supports 202, 204 (when brought into operable alignment with one another) corresponds to (i.e., has the same shape as) the peripheral configuration of the engagement tools 206, the peripheral configuration of the fasteners 108 of a part 100, and the outer shape of the portion 106a of the part around which the base supports 202, 204 are to be deployed. For example, the periphery, peripheral configuration, part, etc. may all be circular. In another embodiment, the inner periphery 210 is of a different shape or configuration than the peripheral configuration of the engagement tools and fasteners. An example is shown in FIG. 8, which is a top plan view of an apparatus 200 as deployed around a part 100 having a square shaft-like body 106a. Here, engagement tools 206 are arranged in a circular peripheral configuration, which matches the circular peripheral configuration of fasteners deployed about a flange of the part 100, e.g., the part 100 may have a square shaft-like body 106a terminating at a circular flange, with fasteners being positioned around the flange in a circular periphery. However, the inner periphery 210 of the base supports 202, 204, when the base supports are brought into operable alignment with one another as shown for example in FIG. 8 (e.g., end edges abutting for the base supports to form an interior and the engagement tools 206 to be positioned for alignment with fasteners 108), is square in shape, matching the shape of the shaft-like body 106a. Thus, in an embodiment of the apparatus, when the base supports are brought together in operable alignment: (i) the base supports form an inner periphery 210 with an open interior 212, the inner periphery being of a first type of shape (rectangular, circular, oval, etc.); (ii) the first type of shape may correspond to the shape of a body 106a of a part 100 with which the apparatus is to be used; (iii) the engagement tools 206 lie arranged in a peripheral configuration that matches a peripheral configuration of fasteners 108 of the part 100; and (iv) the peripheral configuration is different from the first type of shape (e.g., one is rectangular and the other circular).

In an embodiment, removable spacer units 230 (see FIG. 4A) are provided that are different in shape/configuration then the peripheral configuration of the engagement tools 206. For example, the base supports could have a circular inner edge, but spacer units 230 could be provided to establish a flat inner/interior edge when attached to the inner edge of the base supports, for abutting the base supports with a part having a non-circular/flat edge configuration or shape (e.g., rectangular).

A compound ring gear may be used as a compound peripheral actuator 208 in cases where fasteners are arranged in a circular peripheral configuration. In cases where fasteners are arranged other than as around a circle (see, e.g., the rectangular peripheral configuration in FIG. 7), a flexible compound peripheral actuator may be used instead. To explain further, generally speaking, the compound peripheral actuator 208 is a device configured to extend around and simultaneously engage the rotator members 214 of the engagement tools 206, wherein when the compound peripheral actuator is rotated or otherwise moved tangentially (e.g., in a direction “T”—see FIG. 8—which is a tangent to an axis “A” of the part 100, the axis A also being a line normal to the radial plane P defined by the fasteners 108), all the engagement tools 206 are simultaneously rotated. Thus, “peripheral” actuator refers to being configured to simultaneously engage and rotate/actuate plural engagement tools 206 that are arranged in a peripheral configuration. “Compound” refers to the actuator 208 being operable into “opened” and “closed” positions for deployment around a long part 100 where it is not possible to maneuver the actuator 208 over the end of the part and move it axially down the part; instead, the actuator is opened, moved radially towards the part, and then closed. Examples are shown in FIGS. 2 and 3, in the case where the compound peripheral actuator 208 is a compound ring gear. In FIG. 2, the compound ring gear comprises two semi-circular ring gear halves, each having teeth 222, which are detachable from one another (as shown) for positioning around a part. For purposes of detachably connecting the ring gear halves to one another, they may be outfitted with complementary connection means, such as clips, clasps, hooks, latches, bayonet mounts, or the like. When the ring gear halves are brought together in operable alignment (e.g., so as to lie co-planar, with respective ends of the halves abutting as shown in FIG. 4B), they form a complete, operable ring gear. In FIG. 3, the compound ring gear comprises two semi-circular ring gear halves, each having teeth 222. The two halves are hinged together at respective first ends of the halves with a hinge 232. In a first position, the halves are rotated away from one another, via the hinge 232, to form an opening 234 between the respective second ends of the halves. Here, the compound ring gear 208 may be moved radially around a part by moving the ring gear over the part through the opening 234. Then, in a second position, the halves are rotated towards one another until the second ends abut and the opening 234 is closed. Prior to this, the ring gear is aligned with the engagement tools so that the teeth of the ring gear will engage the pinion gears of the engagement tools. The ring gear halves may be detachably connected to one another at that end using a clip, clasp, hook, latch, bayonet mounts, or the like 236. More specifically, one of the ring gear halves may be provided with a first detachable connector, and the other of the ring gear halves may be provided with a second, complementary detachable connector.

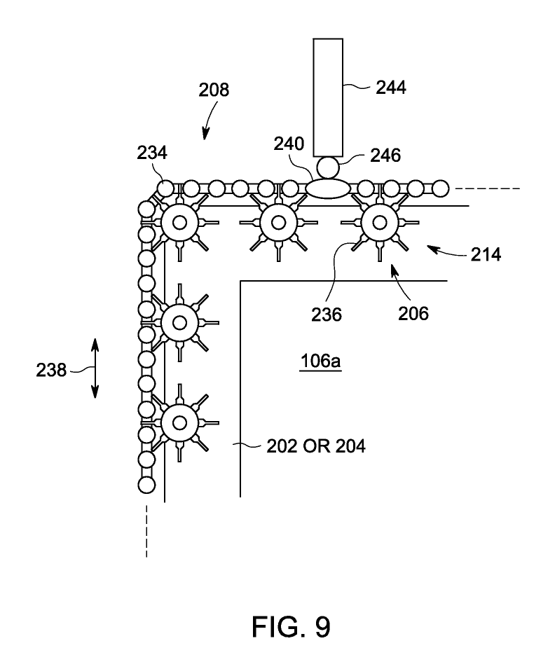

FIG. 9 shows an embodiment of the apparatus for actuating fasteners where the compound peripheral actuator 208 is a flexible compound peripheral actuator 234, for use with an apparatus for actuating fasteners where the fasteners are arranged in a rectangular restricted peripheral configuration. (As should be appreciated, FIG. 9 only shows a portion of one base support of the apparatus—the other portions would be similar to what is shown in FIG. 9.) Here, the flexible compound peripheral actuator 234 is a chain drive, specifically, a length of chain where the ends of the chain may be selectively detachably linked together to form a continuous loop of chain. Instead of pinion gears, each of the rotator members 214 of the engagement tools 206 is a sprocket wheel 236 having sprocket teeth dimensioned to fit in the chain drive so that when the chain is moved in the directions indicated by arrow 238 in FIG. 9, the sprocket wheels simultaneously rotate and the engagement tools simultaneously rotate. In operation, the base supports 202, 204 are brought into operable alignment with one another, forming a periphery (in this example, rectangular) of engagement tools 206 that align with the peripheral configuration of fasteners 108 of a part 100 to be connected to or disconnected from another part 102. The chain drive of the flexible compound peripheral actuator 234 is operated (if needed) to form a single, non-closed length of chain. The length of chain is wrapped around the part 100 and brought into engagement with the sprocket wheels 236. The length of chain may be sized (in terms of length) so that it just fits around all the sprockets, with the ends of the chain lying adjacent to one another when so deployed around the sprocket wheels. The ends of the length of chain are then detachably connected to one another to form a closed chain loop, using a chain connector member 240 or the like. (A chain connector member is a section or link of chain that is specially configured to facilitate the quick attachment of two ends of chain together; examples are found in bicycle and motorcycle drive chains.) With the chain now forming a closed loop and being engaged with the sprocket wheels, movement of the chain in direction(s) 238 causes simultaneous rotation of the engagement tools. More specifically, movement of the chain in one direction will cause rotation of the engagement tools in a first direction for tightening fasteners, and movement of the chain in the other direction will cause rotation of the engagement tools in a second direction for loosening fasteners.

The compound peripheral actuator 208 may be moved (for rotating the engagement tools) manually, or by using a torque wrench or other powered tool. For this purpose, the compound peripheral actuator 208 may be provided with features for facilitating manual and/or machine movement of the compound peripheral actuator. One example is shown in FIG. 4B, where each half of a compound ring gear is provided with a handle 242. Another example is shown in FIG. 9, where the flexible compound peripheral actuator 234 is provided with a handle 244 attached to the chain connector member 240 via a hinge 246.

As discussed, in certain modes of operation the compound peripheral actuator 208 is aligned and brought into engagement with the rotator members 214 of the engagement tools 206. To facilitate this alignment and engagement, the base supports 202, 204 may be dimensioned or otherwise provided with features for supporting and aligning the compound peripheral actuator 208. An example is shown in FIGS. 4A, 4B, and 6. Here, in an embodiment of the apparatus 200, the base supports 202, 204 each include a plurality of landings 248 that extend radially outwards past the periphery of the engagement tools. (In FIGS. 4A and 4B, the landings are shown only on one of the base supports 202; however, if landings are provided in an embodiment, they would typically be provided on both/all base supports.) To align and bring the compound peripheral actuator 208 into engagement with the engagement tools 206, the compound peripheral actuator is simply moved into place so that its side edge rests against the landings, as best shown in FIG. 6. The parts are dimensioned so that when the compound peripheral actuator is in this position, the teeth of the compound peripheral actuator 208 align with the teeth of the pinion gear rotator members. (The same is true where the compound peripheral actuator and rotator members utilize a sprocket/chain configuration or other non-gear configuration.) Instead of landings, the base supports may be made wider, to extend past the radially outermost edge/periphery of the engagement tools, for supporting the compound peripheral actuator.

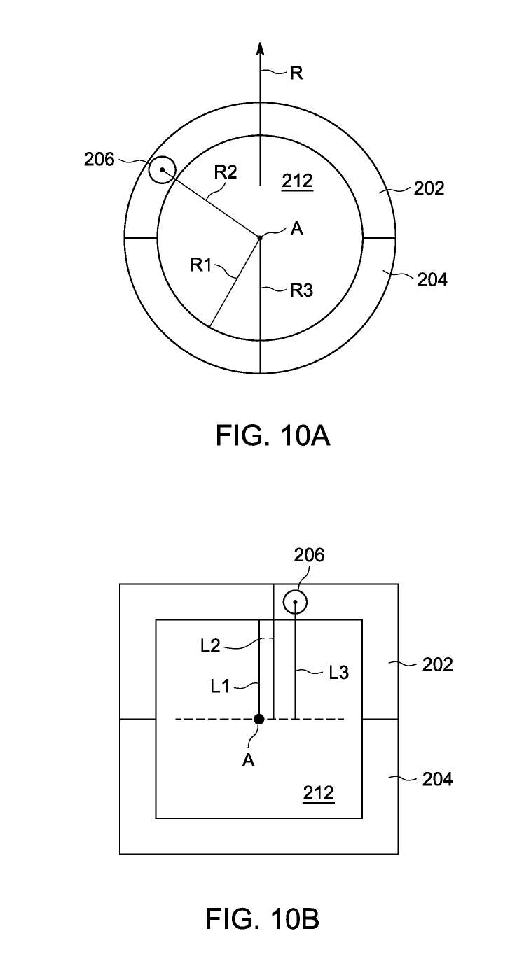

In an embodiment, when the base supports are brought into operable alignment to form a periphery with an open interior 212 (no portion of the device lies within the open interior), the smallest dimension of the open interior, measured from the central axis A of the apparatus, is substantially larger than the smallest cross-width of the base plates (the cross-width being a radial width defined in the direction of “R” in FIG. 10A). In the case of a circular periphery, as shown in FIG. 10A: R3−R1<<R1; or, in the case of a rectangular periphery, as shown in FIG. 10B: L3−L1<<L1. In an embodiment, “substantially” larger means 3× larger or greater than 3× larger, i.e., R1>=(R3−R1)*3 or L1>=(L3−L1)*3. In another embodiment, when the base supports are brought into operable alignment to form a periphery with an open interior, the smallest dimension of the open interior, measured from the central axis A of the apparatus, is substantially larger than the shortest distance between the inner edge of the base plate and the center point of the engagement tools. In the case of a circular periphery, as shown in FIG. 10A: R2−R1<<R1; or, in the case of a rectangular periphery, as shown in FIG. 10B: L2−L1<<L1. In an embodiment, in this context “substantially” larger means 3× larger or greater than 3× larger, i.e., R1>=(R2−R1)*3 or L1>=(L2−L1)*3. In another embodiment, the open interior 212 has an area of at least 100 square cm. In another embodiment, the open interior 212 is circular and has an area of at least 100 square cm. In each of these instances/embodiments, the relatively large open interior reflects that the apparatus may be used with parts 100 where the shaft-like body of the part (or other portion of the part that creates a restricted configuration for accessing fasteners) is relatively wide.

In another embodiment, the open interior is not quite as substantially large with respect to the width of the base supports and/or positioning of the engagement tools. Instead, when the base supports are brought into operable alignment to form a periphery with an open interior 212, the smallest dimension of the open interior (e.g., L1 or R1), measured from the central axis A of the apparatus, is equal to or greater than the smallest cross-width of the base plates (e.g., R3−R1 or L3−L1) and/or the shortest distance between the inner edge of the base plate and the center point of the engagement tools (e.g., R2−R1 or L2−L1).

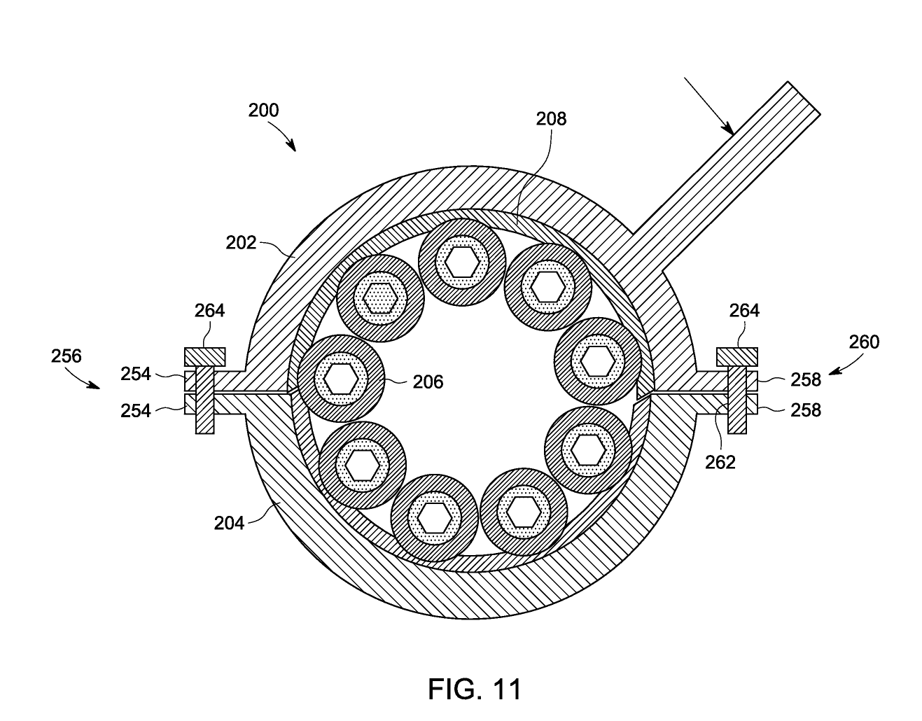

As with the compound ring gear shown in FIG. 3, the base supports 202, 204 may be attached to one another at a first end by a hinge joint 250. Additionally, the base supports may include complementary clasp members 252 for selectively engaging the base supports together at a second end. FIG. 11 illustrates another means for detachably connecting base supports 202, 204 to one another. As indicated, each base support includes a first end flange 254 at a first end 256 of the base support and a second end flange 258 at a second end 260 of the base support. The flanges are positioned and include complementary-sized apertures 262, so that when the base supports are brought together into operable alignment, as shown in FIG. 11, the flanges of the adjacent ends of the base supports abut and the apertures align. The base supports 202, 204 may be detachably connected to one another by disposing fasteners 264 through the apertures 262. Although base supports 202, 204 are shown with flanges 254, 258 in FIG. 11, this connection means is also applicable for use with a compound ring gear or other compound peripheral actuator, i.e., the parts of a compound ring gear may be outfitted with flanges as shown in FIG. 11.

Although embodiments are shown with two base supports configured to be brought together into operable alignment to form a complete periphery, an apparatus could be provided having more than two base supports. The more than two base supports could be hinged together (e.g., each base support hinged to at least on neighboring base support) or otherwise configured for detachable connection to one another.

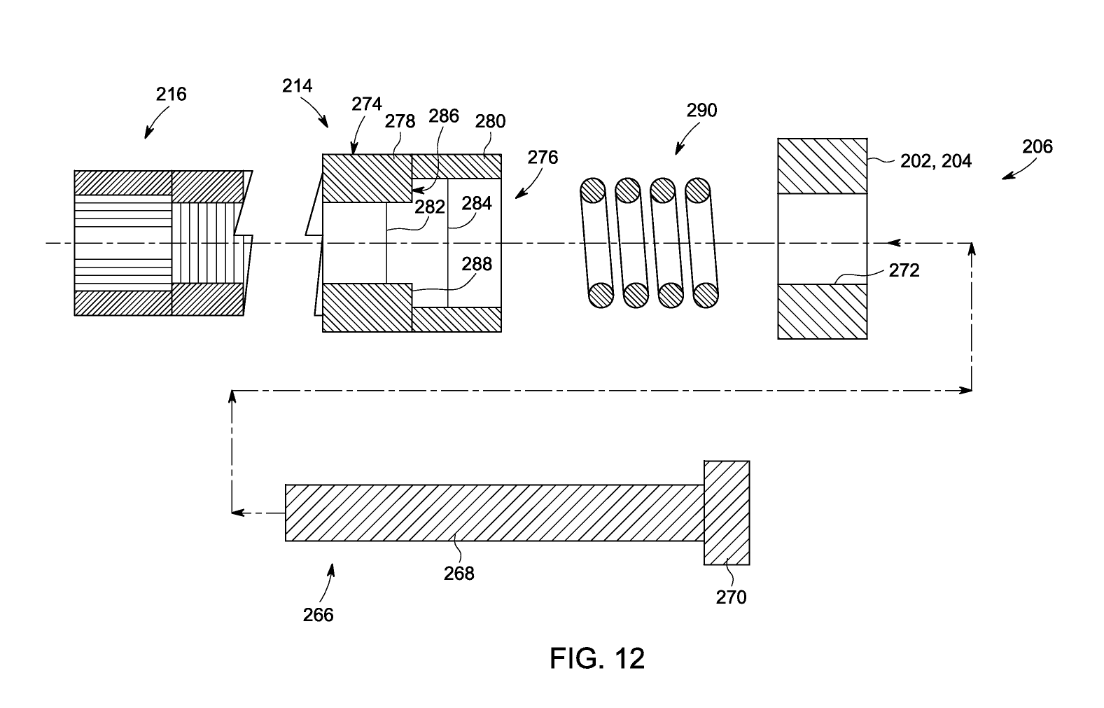

The apparatus 200 may be provided with different types or configurations of engagement tools 206, depending, for example, on the shape/configuration of the fasteners 108 to be actuated. FIG. 12 shows one embodiment of an engagement tool 206, similar to the one shown in FIG. 6. Here, the engagement tool 206 comprises a shaft 266 coupled to a base support 202 or 204. (The term “coupled” includes non-moving attachment and floating/moving attachment.) The shaft 266 includes a shaft body 268 and a head 270. The body 268 extends through an aperture 272 provided in the base support, with the head 270 being wider than the aperture 272 to prevent the shaft 266 from passing all the way through the base support; that is, as the shaft body 268 is passed through the aperture 272 in the direction indicated by the arrows in FIG. 12, the head 270 eventually contacts the base support 202, 204 around the aperture 272, preventing the shaft from moving any further. The rotator member 214 is a pinion gear 274 having a longitudinal through-bore 276. The pinion gear 274 is disposed about the shaft 266, with the shaft 266 extending through the through-bore 276. The pinion gear 274 comprises a first pinion gear section 278 and a second pinion gear section 280, which are attached to and coaxial with one another. The first pinion gear section 278 defines a first section of the through-bore having a first diameter 282, and the second pinion gear section 280 defines a second section of the through-bore having a second, larger diameter 284. An interior end 286 of the first pinion gear section 278, defined between the first diameter and the second diameter, forms a landing 288. The engagement tool further comprises a spring 290 positioned within the second section of the through-bore in the second pinion gear section of the pinion gear, and disposed over the shaft (similar to as shown in FIG. 6). The spring 290 abuts the landing 288 and/or the first or second base support 202, 204, as applicable. That is, the spring 290 is sandwiched between the landing and the base support. The spring provides the engagement tool (or, more specifically, the rotator member and the fastener coupler) with a degree of freedom of movement to accommodate variances in fastener spacing, and also helps to control torque applied to a fastener through the engagement tool 206. The fastener coupler 216 (socket or otherwise) is attached to the pinion gear 274 on the side of the pinion gear away from the shaft 266, for detachable coupling with the head or other designated portion of a fastener 108. The fastener coupler 216 may be permanently connected to the pinion gear (or other rotator member) or it may be detachably connected to the pinion gear (or other rotator member).

The diameter of the aperture 272 may be the same as the diameter of the shaft body 268. In another embodiment, the diameter of the aperture 272 is slightly larger than the diameter of the shaft body 268, to provide a degree of play there between for facilitating variances in fastener spacing, in conjunction with the spring 290 or otherwise. In an embodiment, one or both of the fastener coupler 216 and the rotator member 214 are connected to the shaft body 268, for securing the fastener coupler 216, rotator member 214, and spring 290 in place. In another embodiment, only the rotator member 214 is connected to the shaft body. Parts can be connected to the shaft body through an interference fit (e.g., between the shaft body and first section of the through-bore 276, which is the portion defined by diameter 282), by using a key/spline device, by using threads, by using a permanent connection (e.g., adhesive or welding), by using retaining pins, by using a shear key, or the like. In an embodiment, the diameter of the aperture 272 is slightly larger than the diameter of the shaft body 268, and the rotator member 214 is attached to the end of the shaft body 268 such that when the head 270 abuts the base support (202 or 204), the rotator member 214 lies slightly away from the base support, with the spring 290 sandwiched between the rotator member (e.g., landing 288) and base support. In such a configuration, the spring 290 normally pushes the fastener coupler 216 outwards, but the fastener coupler 216 can nevertheless travel both radially back-and-forth and axially inwards to an extent defined by (i) the difference in spacing between the shaft body 268 and aperture 272 and (ii) the distance between the rotator member and base support and/or the maximum extent of spring compression, respectively.

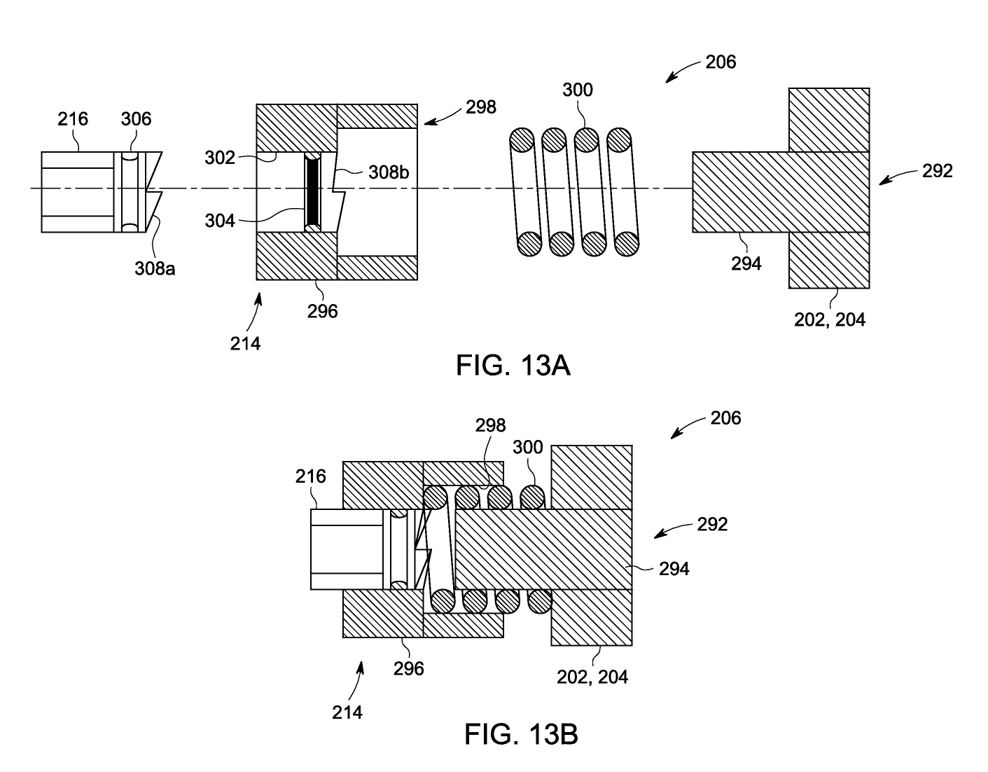

FIGS. 13A and 13B show another embodiment of an engagement tool 206. Here, the engagement tool 206 comprises a shaft 292 attached to a base support 202 or 204. (The shaft 292 may be similar to the shaft 266; in FIGS. 13A and 13B, however, only a shaft body 294 is shown.) The rotator member 214 is a pinion gear 296 having a longitudinal through-bore 298 that is similar to the through-bore of the pinion gear shown in FIG. 12. A spring 300 is positioned within the pinion gear, and disposed over the shaft 292, similar to the device shown in FIG. 12. In this embodiment, the fastener coupler 216 (socket or otherwise) is detachably coupled to the pinion gear 296. In particular, the first section 302 of the through-bore 298 includes a ridge or other raised protuberance, a spring-loaded ball or protuberance, a deformable bushing, or another gripper member 304 for releasably gripping a fastener coupler 216. The gripper member 304 is attached to the pinion gear 296 (or other rotator member 214) within the first section 302 of the through-bore 298. The fastener coupler 216 has an outer diameter dimensioned so that the fastener coupler can fit within the first section 302 of the through-bore 298, as shown in FIG. 13B. The fastener coupler 216 includes a complementary gripper feature 306, e g , annular groove, indent, socket, or the like, that releasably engages the gripper member 304 when the fastener coupler 216 is fully inserted into the rotator member 214. (“Releasably” engages means the fastener coupler 216 is firmly held in place when fully inserted into the rotator member but can be manually removed with a firm tug.) The fastener coupler 216 and/or rotator member 214 may include stops 308a, 308b or another feature for preventing rotation of the fastener coupler 216 with respect to the rotator member 214 (i.e., the stops facilitate the fastener coupler rotating along with the rotator member when the rotator member is acted upon by a compound peripheral actuator).

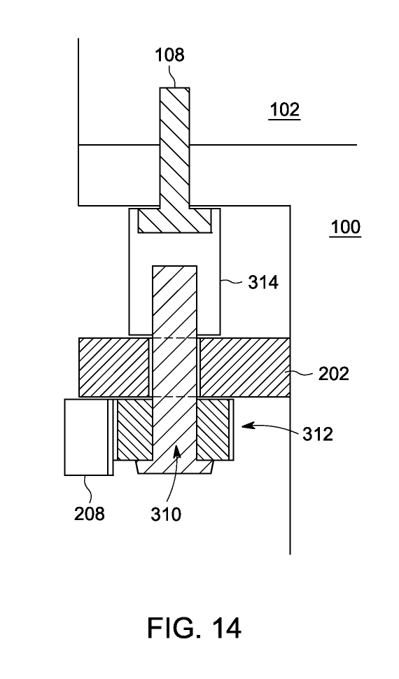

Although certain of the figures show the apparatus as using an arrangement comprising first the base supports 202, 204, then the rotator member 214, and then the fastener coupler 216 (see, e.g., FIG. 6), this is for illustration purposes only, and these elements may, in certain embodiments, be ordered differently. One example is shown in FIG. 14. Here, an engagement tool 206 is attached to a base support 202, and comprises a shaft 310, a rotator member 312, and a fastener coupler 314. The shaft 310 extends through an aperture provided in the base support 202 for this purpose. The rotator member 312 is located on one side of the base support 202 (from the perspective of FIG. 14, a lower side), with the shaft 310 extending through the rotator member 312 and the rotator member 312 being held in place by a head of the shaft. The fastener coupler 314 is location on the other side of the base support 202 (from the perspective of FIG. 14, a top side), with the shaft extending into the fastener coupler (or the shaft could be otherwise attached to the fastener coupler. Thus, the fastener coupler is located on one side of the base support and the rotator member on the other side. For simplicity of illustration, FIG. 14 does not shown an interior spring within the rotator member, but the spring features of the other drawings are applicable to the arrangement of FIG. 14.

In an embodiment, the engagement tools 206 of the apparatus 200 are all the same. In another embodiment, the engagement tools 206 are all the same, except that the fastener couplers 216 of some of the engagement tools (e.g., one of the engagement tools or a first plurality of the engagement tools) have a first configuration, and the fastener couplers 216 of the other engagement tools (e.g., one of the other of the engagement tools or a second, distinct plurality of the engagement tools) have a second, different configuration (or possibly third, fourth, etc. different configurations). As should be appreciated, in this embodiment the rotator members 214 and all other parts of the engagement tools other than the fastener couplers would be the same. In another embodiment, the engagement tools 206 are different, e.g., one of the engagement tools or a first plurality of the engagement tools each have a first configuration, and the other engagement tools (e.g., one of the other of the engagement tools or a second, distinct plurality of the engagement tools) each have a second, different configuration (or possibly third, fourth, etc. different configurations). As should be appreciated, in this embodiment the rotator members of certain of the engagement tools could be different from one another (e.g., different gear pitches) with the compound peripheral actuator having various sections each configured to engage a different type of rotator member. (Here, the compound peripheral actuator might have to be aligned so that its different sections engaged the appropriate rotator members.)

In summary of an embodiment of the apparatus 200 in operation, the apparatus is used to simultaneous actuate a plurality of fasteners 108 arranged in a restricted peripheral configuration, such as shown in FIG. 1B. For example, the fasteners may be arranged as around a circle for attaching two parts 100, 102 together. In use, base supports 202, 204 are separated from one another, such as shown in FIGS. 2, 3, and 7, and moved radially around a part 100 (see arrow “D1” in FIG. 1B). The base supports 202, 204 are then brought into operable alignment, with their ends abutting as shown in FIG. 4A. (The base supports are oriented so the fastener couplers face the fasteners.) The base supports may be detachably connected together if means are provided for doing so. Then, the base supports 202, 204 are moved axially towards the fasteners 108, as indicated by arrow “D2” in FIG. 1B, for engagement of the fastener couplers 206 with the fasteners. Alternatively, it could be the case that each base support is separately moved into place for engagement of its fastener couplers with fasteners 108, with the base supports subsequently being detachably connected to one another. Next, the compound peripheral actuator 208 is opened as shown in FIGS. 2 and 3. The compound peripheral actuator 208 is moved radially around the part 100 (direction D1 in FIG. 1B), and is closed in alignment with the rotator members 214 (FIG. 4B) for engagement of the compound peripheral actuator 208 with the rotator members 214. The compound peripheral actuator is then turned/rotated from the outside, using a power tool or otherwise to torque all the fasteners simultaneously. Each individual engagement tool 206 has individual control over the torque applied to its respective fasteners 208, with the help of the internal springs (e.g., 290, 300) and geometry between the rotator members and fastener couplers. For cases where one part is to be connected to a second part, the fastener couplers can be loaded with fasteners before deploying the apparatus around a part.

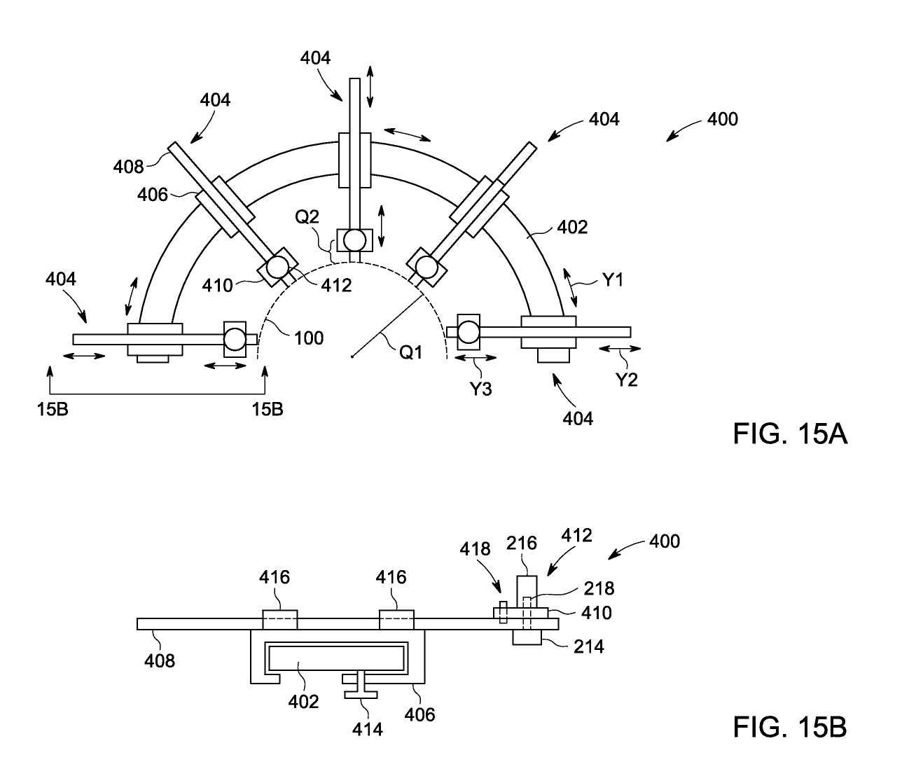

In certain of the embodiments described above, the engagement tools 206 are fixed in place (except for a small degree of movement to accommodate manufacturing variances), and as such each instance of the apparatus is used for a particular part and fastener configuration. That is, for a first fastener arrangement (e.g., spacing between fasteners, shape of peripheral configuration, distance from a part axis), a first size/configuration of apparatus is provided, and for a second, different fastener arrangement a second size/configuration of apparatus is provided. Of course, this is perfectly suitable for assembly of multiple instances of standard sized parts. In another embodiment of the apparatus, however, the number, spacing, and positioning of engagement tools is user selectable, within certain parameters. An example is shown in FIGS. 15A and 15B, which illustrate one half of an apparatus 400 for actuating fasteners (the other half would be the same as or similar to what is shown in FIG. 15A). The apparatus 400 would comprise an arcuate, semi-circular base support 402 and a plurality of engagement tool assemblies 404. Each engagement tool assembly 404 comprises a base slide 406, a radial slide 408, an engagement tool support 410, and an engagement tool 412. The base slide 406 is configured to slide along the base support 402 in a tangential direction “Y1,” and can be locked into place at any point along the base support. For example, as shown in FIG. 15B, the underside of the base slide 406 may be outfitted with a screw or turn knob 414 that can be turned to frictionally engage the base support 402. The radial slide 408 is slidably connected to the base slide 406 (e.g., via slide supports 416), and can be moved in a radial direction “Y2.” The radial slide 408 can be locked into place at any point with respect to the base slide, using, for example, a screw or turn knob (not shown) similar to knob 414 that extends down through a slide support 416 for selectively engaging and holding the radial slide 408 in place. The engagement tool support 410 can be radially slid along the radial slide 408, in a direction “Y3.” The engagement tool support 410 can be locked into place at any point along the radial slide 408, using a lock pin 418 or other lock member, for example. The engagement tool 412 is attached to the engagement tool support 410. The engagement tool 412 may comprise an engagement tool such as shown in FIGS. 6 and 14 (namely, a shaft 218, rotator member 214, and fastener coupler 216).

In operation, for initial setup of the apparatus 400, a user would select as many engagement tool assemblies 404 as half the number of fasteners 108 of a part 100. (For example, if eight fasteners are arranged circularly around a part, half the apparatus as shown in FIG. 15 would accommodate one half of the eight fasteners, assuming the fasteners are symmetrically arranged.) The user would then slide the base slides 406 of the assemblies 404 over the base support 402, positioning the base slides a distance/angular degree apart that corresponds to the spacing of the fasteners. The base slides 406 would then be locked into place. The user would then position each radial slide 408. The radial slides could be positioned to that the distance “Q1” between a center point of the apparatus 400 and the innermost end of the radial slide 408 equals the radius of the part 100 against which the apparatus 400 will be moved into place (here, assuming a circular shaft such as shown in FIG. 1A). The various parts of the apparatus could be provided with measurement rules or scales for quickly determining distances and for providing consistency between positioning the various assemblies. Next, the engagement tool support 410 would be into place and locked, for example, at a distance “Q2” that corresponds to the distance between the part body 106a and the center point of the fastener 108.

Once the apparatus 400 was initially set up, the engagement tools 412 would lie locked into position, arranged in a periphery that corresponds to the peripheral configuration of fasteners 108 of a part 100. The apparatus would then be moved into place as described above (more specifically, the two halves would be moved into place), and a compound peripheral actuator would be deployed to simultaneously rotate all the engagement tools. Since the positioning of the engagement tools is variable, a flexible compound peripheral actuator, such as shown in FIG. 9, could be used.

As noted above, a peripheral configuration refers to an arrangement of a mechanical system or device (e.g., two abutting parts), where there are plural fasteners (e.g., for connecting the two abutting parts together) located around a periphery or boundary, but without any fasteners located within the interior area defined by the periphery. Typically, the fasteners are co-planar. A restricted peripheral configuration is one where the interior area is occupied by a portion of the mechanical system or device that does not allow practical access by a tool that must be positioned coaxial with the interior area. In a typical example of a restricted peripheral configuration, the distal ends “D” (see FIG. 6) of the fasteners (e.g., engagement head of a bolt, or other portion of a fastener located away from the portion of the fastener connecting the two abutting parts), when fully tightened into place, define a substantially common plane “P”; a portion of the mechanical system or device located within the interior area extends from and past the plane, in a direction “X” opposite the direction in which the fasteners extend (i.e., that portion of the mechanical system or device extends away from the fasteners). A “regular” peripheral configuration is one where the fasteners are spaced equidistantly from one another. A peripheral configuration characterized in reference to a particular shape, e.g., circle/circular, square, rectangle/rectangular, or the like, is one where fasteners are arranged around a periphery in that shape. Thus, a regular circular peripheral configuration is where fasteners are arranged equidistantly from one another as around a circle.

Unless otherwise specified within a particular descriptive context, the term “substantially” means exhibiting the stated characteristic but for possible dimensional variations due to manufacturing tolerances, typically one percent or less.

In an embodiment, the open interior defined by the base supports (when brought together into operable alignment) includes an open portion that encompasses at least the geometric center of the apparatus. That is, in an embodiment, at least the geometric center of the apparatus is open (when the base supports are brought together into operable alignment). “Open” means extending all the way through the apparatus and unoccupied by any part of the apparatus, such that a body moving longitudinally with respect to the apparatus (i.e., along or parallel to a longitudinal axis of the apparatus) could pass into the open portion/opening/open interior and all the way through and past the apparatus, unimpeded (as opposed to a blind hole, slot, or indentation).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person skilled in the art to practice the embodiments of invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present invention will be better understood when read in conjunction with the appended drawings. To the extent that the figures illustrate diagrams of the functional blocks of various embodiments, the functional blocks are not necessarily indicative of the division between elements. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described apparatus for actuating fasteners, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. An apparatus for actuating fasteners comprising:
at least first and second base supports that when brought into operable alignment form a periphery with an open interior;
a plurality of engagement tools rotatably coupled to the at least first and second base supports, each engagement tool comprising a rotator member and a fastener coupler connected to the rotator member; and
a compound peripheral actuator dimensioned to extend around and engage the rotator members of the engagement tools around the periphery, wherein when the compound peripheral actuator is deployed to engage the rotator members, movement of the compound peripheral actuator causes rotation of the plurality of engagement tools for simultaneous rotation of fasteners connected to the fastener couplers of the engagement tools.

2. The apparatus of claim 1, wherein each engagement tool comprises:
a shaft attached to one of the at least first and second base supports;
the rotator member disposed about the shaft, the rotator member comprising a pinion gear having a longitudinal through-bore, wherein the shaft extends through the through-bore; and
the fastener coupler attached to the pinion gear.

3. The apparatus of claim 2, wherein:
the pinion gear comprises first and second pinion gear sections, the first and second pinion gear sections being attached to and coaxial with one another, the first pinion gear section defining a first section of the through-bore having a first diameter, and the second pinion gear section defining a second section of the through-bore having a second, larger diameter, wherein an interior end of the first pinion gear section that is defined between the first diameter and the second diameter forms a landing; and
the engagement tool further comprises a spring disposed over the shaft and positioned within the second section of the through-bore in the second pinion gear section of the pinion gear, the spring abutting the landing and/or said one of the at least first and second base supports.

4. The apparatus of claim 3, wherein the fastener coupler is a socket.

5. The apparatus of claim 1, wherein each of the base supports is an arcuate semi-circle, and the periphery is circular, the plurality of engagement tools being positioned regularly around the circular periphery when the first and second base supports are brought into operable alignment.

6. The apparatus of claim 5, wherein each engagement tool comprises:
a shaft attached to one of the at least first and second base supports;
the rotator member disposed about the shaft, the rotator member comprising a pinion gear having a longitudinal through-bore, wherein the shaft extends through the through-bore; and
the fastener coupler attached to the pinion gear.

7. The apparatus of claim 6, wherein the compound peripheral actuator is a compound ring gear dimensioned to engage the pinion gears when the first and second base supports are brought into operable alignment to form the circular periphery.

8. The apparatus of claim 5, wherein the base supports are attached to one another at a first end by a hinge joint, and wherein the base supports comprise complementary clasp members for selectively engaging the base supports together at a second end of the base supports.

9. The apparatus of claim 5, wherein the open interior is circular, and no portion of the apparatus lies within the open interior.

10. An apparatus for actuating fasteners comprising:
first and second arcuate, semi-circular base supports that when brought into operable alignment form a circular periphery with an open interior, wherein no portion of the apparatus lies within the open interior, the base supports being at least partially separable from one another for the base supports to be moved radially towards and deployed about a part;
a plurality of engagement tools rotatably coupled to the first and second base supports and positioned regularly around the circular periphery, each engagement tool comprising a pinion gear and a fastener coupler connected to the pinion gear; and
a compound ring gear dimensioned to extend around and engage the pinion gears of the engagement tools around the periphery, wherein when the compound ring gear is deployed to engage the pinion gears, movement of the compound ring gear causes rotation of the plurality of engagement tools for simultaneous rotation of fasteners connected to the fastener couplers of the engagement tools.

11. The apparatus of claim 10, wherein each engagement tool comprises a shaft attached to one of the at least first and second base supports, wherein the pinion gear is disposed about the shaft.

12. The apparatus of claim 11, wherein:
the pinion gear defines a longitudinal through-bore, wherein the shaft extends through the through-bore;
the pinion gear comprises first and second pinion gear sections, the first and second pinion gear sections being attached to and coaxial with one another, the first pinion gear section defining a first section of the through-bore having a first diameter, and the second pinion gear section defining a second section of the through-bore having a second, larger diameter, wherein an interior end of the first pinion gear section that is defined between the first diameter and the second diameter forms a landing; and
the engagement tool further comprises a spring disposed over the shaft and positioned within the second section of the through-bore in the second pinion gear section of the pinion gear, the spring abutting the landing and/or said one of the at least first and second base supports.

13. The apparatus of claim 12, wherein the fastener coupler is a socket.

14. An apparatus for actuating fasteners comprising:
first and second base supports extending around a periphery of a shaft body of a first part abutting a second part;
a first plurality of engagement tools rotatably coupled to the first base support, and a second plurality of engagement tools rotatably coupled to the second base support, each engagement tool comprising a rotator member and a fastener coupler connected to the rotator member, wherein the fastener coupler engages a fastener for connecting the first part and the second part; and
a compound peripheral actuator extending around and engaging the rotator members of the engagement tools around the periphery, wherein movement of the compound peripheral actuator causes rotation of the plurality of engagement tools for simultaneous rotation of fasteners connected to the fastener couplers of the engagement tools, thereby connecting or disconnecting the first part to the second part.

15. The apparatus of claim 14, wherein each engagement tool comprises:
a shaft attached to one of the first base support or the second base support;
the rotator member disposed about the shaft, the rotator member comprising a pinion gear having a longitudinal through-bore, wherein the shaft extends through the through-bore; and
the fastener coupler attached to the pinion gear.

16. The apparatus of claim 15, wherein:
the pinion gear comprises first and second pinion gear sections, the first and second pinion gear sections being attached to and coaxial with one another, the first pinion gear section defining a first section of the through-bore having a first diameter, and the second pinion gear section defining a second section of the through-bore having a second, larger diameter, wherein an interior end of the first pinion gear section that is defined between the first diameter and the second diameter forms a landing; and
the engagement tool further comprises a spring disposed over the shaft and positioned within the second section of the through-bore in the second pinion gear section of the pinion gear, the spring abutting the landing and/or said one of the at least first and second base supports.

17. The apparatus of claim 16, wherein the fastener coupler is a socket.

18. The apparatus of claim 14, wherein the shaft body of the first part is circular in cross section, and each of the base supports is an arcuate semi-circle for extending around the shaft body.

19. The apparatus of claim 18, wherein the rotator member of each engagement tool comprises a pinion gear.

20. The apparatus of claim 19, wherein the compound peripheral actuator is a compound ring gear engaging the pinion gears.
